(19) United States
(12) Patent Application Publication
(10) Pub. No.: US 2013/0119808 A1
(43) Pub. Date: May 16, 2013

(54) MOTOR

(71) Applicant: Nidec Corporation, Minami-ku (JP)

(72) Inventors: Tsuyoshi HIROKAWA, Kyoto (JP); Toshinobu SHINOHARA, Kyoto (JP); Tomoyoshi YOKOGAWA, Kyoto (JP); Yoshihiro UCHITANI, Kyoto (JP)

(73) Assignee: NIDEC CORPORATION, Minami-ku (JP)

(21) Appl. No.: 13/657,248

(22) Filed: Oct. 22, 2012

(30) Foreign Application Priority Data
Nov. 10, 2011 (JP) 2011-246973
Sep. 12, 2012 (JP) 2012-200129

(51) Int. Cl. H02K 1/27

(52) U.S. Cl. 310/156.43

(57) ABSTRACT

A rotary unit of a motor includes a shaft, a ring-shaped plate, a rotor core defined by a plurality of core pieces, and a plurality of magnets arranged along the circumferential direction. The core pieces and the magnets are alternately arranged in the circumferential direction. The ring-shaped plate and the respective core pieces are fixed to each other by combining the recesses provided in one of the ring-shaped plate and the respective core pieces and the protrusions provided in the other of the ring-shaped plate and the respective core pieces or combining a first through-hole provided in the ring-shaped plate and a protrusion provided in each of the core pieces. The core pieces are fixed to the ring-shaped plate without having to provide a through-hole in each of the core pieces. This reduces a magnetic resistance of each of the core pieces.

### BACKGROUND OF THE INVENTION

1. Field of the Invention

The present invention relates to an inner-rotor-type motor, and more specifically, to an inner-rotor-type motor including a permanent magnet rotor.

2. Description of the Related Art

Conventionally, there is known a so-called inner-rotor-type motor in which a rotary unit having magnets is arranged inside a stator having coils. A permanent-magnet-type rotor disclosed in, e.g., Japanese Utility Model Application Publication No. H04-002946, is applicable to the rotary unit of the inner-rotor-type motor. The permanent-magnet-type rotor of Japanese Utility Model Application Publication No. H04-002946 has a structure in which iron cores formed by laminating sector-shaped thin steel plates one above another and permanent magnets are alternately arranged along a circumferential direction (see, for example, the claims of Japanese Utility Model Application Publication No. H04-002946).

In the permanent-magnet-type rotor of Japanese Utility Model Application Publication No. H04-002946, end rings are provided on the axial opposite end surfaces of the iron cores. Penetration pins are fitted into the slots of the iron cores and the end rings. The opposite ends of the penetration pins are subjected to caulking (see, for example, the claims and FIGS. 1 and 2 of Japanese Utility Model Application Publication No. H04-002946). Thus, the iron cores are fixed to the end rings.

In the structure of Japanese Utility Model Application Publication No. H04-002946, it is presumed that the magnetic resistance of the respective iron cores grows larger due to the slots into which the penetration pins are fitted. If the magnetic resistance of the respective iron cores grows larger, it becomes difficult to efficiently convert the magnetic fluxes generated from the permanent magnets to torque.

### SUMMARY OF THE INVENTION

Preferred embodiments of the present invention provide a motor that includes a plurality of circumferentially arranged core pieces and prevents the core pieces from scattering radially outward while reducing a magnetic resistance of each of the core pieces.

In accordance with a first preferred embodiment of the present invention, there is provided a motor, including: a stationary unit; and a rotary unit supported to rotate with respect to the stationary unit, wherein the rotary unit includes a shaft arranged along a center axis extending in an up-down direction, a ring-shaped plate extending in a radial direction and a circumferential direction with respect to the center axis, a rotor core including a plurality of core pieces and a plurality of magnets arranged along the circumferential direction, the ring-shaped plate is made of a non-magnetic metal material, each of the core pieces includes a plurality of axially-laminated steel plates, each of the magnets includes circumferential opposite surfaces as magnetic pole surfaces, the magnets are arranged such that the same poles are opposed to each other in the circumferential direction, the core pieces and the magnets alternately arrange in the circumferential direction, each of the steel plates includes a protrusion and a recess, at least a portion of the protrusion of each of the steel plates is fitted to the recess of another axially-adjoining steel plates, the ring-shaped plate includes a protrusion, a recess, or a first through-hole, and at least a portion of the protrusion of the steel plate axially adjoining the ring-shaped plate is fitted to the recess or the first through-hole of the ring-shaped plate, or at least a portion of the protrusion of the ring-shaped plate is fitted to the recess of the steel plate axially adjoining the ring-shaped plate.

With the preferred embodiments of the present invention, it is possible to prevent the core pieces from scattering radially outward. It is also possible to fix the core pieces to the ring-shaped plate without having to provide a through-hole in each of the core pieces. This makes it possible to reduce a magnetic resistance of each of the core pieces.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view showing a motor according to a first preferred embodiment of the present invention.

FIG. 2 is a vertical sectional view showing a motor according to a second preferred embodiment of the present invention.

FIG. 3 is a vertical sectional view showing a rotary unit according to the second preferred embodiment of the present invention.

FIG. 4 is a horizontal sectional view of the rotary unit according to the second preferred embodiment of the present invention.

FIG. 5 is a perspective view showing a rotor unit according to the second preferred embodiment of the present invention.

FIG. 6 is a perspective view showing a ring-shaped plate, core pieces, and magnets according to the second preferred embodiment of the present invention.

FIG. 7 is an exploded perspective view of the ring-shaped plate, the core pieces, and the magnet according to the second preferred embodiment of the present invention.

FIG. 8 is a perspective view showing a rotor unit according to a modified example of a preferred embodiment of the present invention.

FIG. 9 is a perspective view showing a rotor unit according to another modified example of a preferred embodiment of the present invention.

FIG. 10 is a perspective view showing a rotor unit according to still another modified example of a preferred embodiment of the present invention.

FIG. 11 is a plan view showing a ring-shaped plate according to still another modified example of a preferred embodiment of the present invention.

FIG. 12 is a horizontal sectional view showing a rotary unit according to still another modified example of a preferred embodiment of the present invention.

FIG. 13 is a vertical sectional view showing a rotary unit according to still another modified example of a preferred embodiment of the present invention.

FIG. 14 is a horizontal sectional view showing a rotary unit according to still another modified example of a preferred embodiment of the present invention.

FIG. 15 is an exploded perspective view showing core pieces and a magnet according to still another modified example of a preferred embodiment of the present invention.

### DETAILED DESCRIPTION OF THE PREFERRED EMBODIMENTS

Hereinafter, illustrative preferred embodiments of the present invention will now be described with reference to the drawings. In the description below, the direction extending along the center axis of a motor will be referred to as “axial direction”. The direction orthogonal to the center axis of a motor will be referred to as “radial direction”. The direction extending along a circular arc about the center axis of a motor will be referred to as “circumferential direction”. The shape and positional relationship of individual components will be described under the assumption that one side in the axial direction is an “upper side” and the other side in the axial direction is a “lower side”. However, these definitions are made merely for the sake of convenience in description and are not intended to limit the direction when the present motor is used.

### First Preferred Embodiment

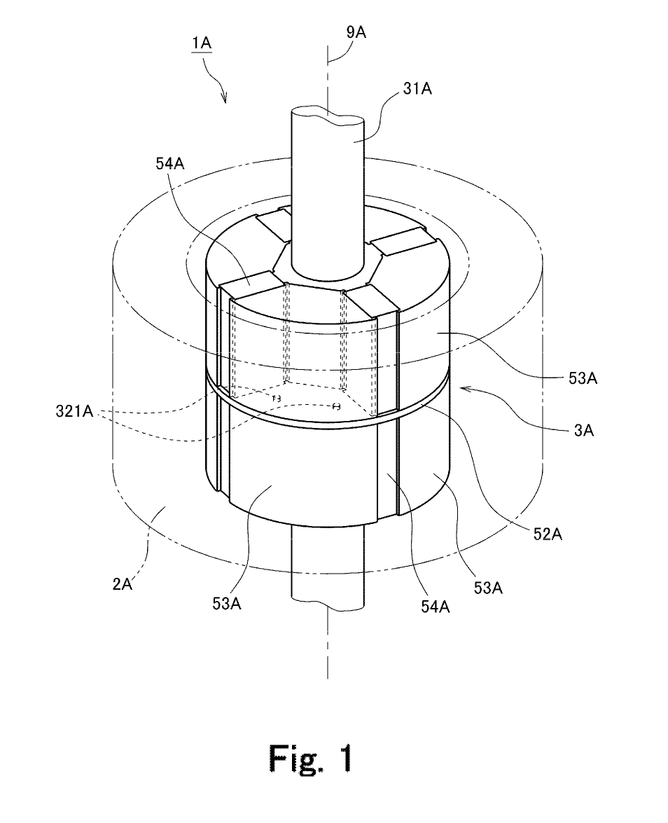

FIG. 1 is a perspective view showing a motor 1A according to a first preferred embodiment of the present invention. The motor 1A preferably includes a stationary unit 2A indicated by double-dot chain lines in FIG. 1 and a rotary unit 3A indicated by solid lines in FIG. 1. The rotary unit 3A is supported to rotate with respect to the stationary unit 2A.

The rotary unit 3A preferably includes a shaft 31A, a ring-shaped plate 52A, a plurality of core pieces 53A, and a plurality of magnets 54A. The shaft 31A is arranged along a center axis 9A extending in the up-down direction. The ring-shaped plate 52A extends in the radial direction and the circumferential direction with respect to the center axis 9A. The core pieces 53A define a rotor core. The magnets 54A are arranged in the circumferential direction.

In the motor 1A, circumferentially opposite end surfaces of the magnets 54A become magnetic pole surfaces. The identical poles of the magnets 54A are preferably opposed to each other in the circumferential direction. The core pieces 53A and the magnets 54A are alternately arranged in the circumferential direction.

The ring-shaped plate 52A and the respective core pieces 53A are preferably fixed to each other in a fixing portion 321A. The fixing portion 321A is preferably defined by combining a recess provided in one of the ring-shaped plate 52A and the core pieces 53A and a protrusion provided in the other of the ring-shaped plate 52A and the core pieces 53A or by combining a first through-hole provided in the ring-shaped plate 52A and a protrusion provided in each of the core pieces 53A. The fixing portion 321A preferably prevents the core pieces 53A from scattering in a radially outward direction during rotation of the rotary unit 3A.

In the motor 1A, the core pieces 53A are preferably fixed to the ring-shaped plate 52A without having to form a through-hole in each of the core pieces 53A. This reduces a magnetic resistance of each of the core pieces 53A.

### Second Preferred Embodiment

Next, description will be made of a second preferred embodiment of the present invention.

The motor 1 of the present preferred embodiment is preferably mounted to, e.g., a motor vehicle, and is used to generate a drive force in, e.g., a steering device. However, the motor of the present invention may be used in other applications. For example, the motor of the present invention may be mounted to other parts of the motor vehicle and may be used as, e.g., a drive power source for an engine cooling fan. Moreover, the motor of the present invention may be mounted to an industrial machine, a home appliance, an OA device or a medical instrument and may be used to generate different kinds of drive forces.

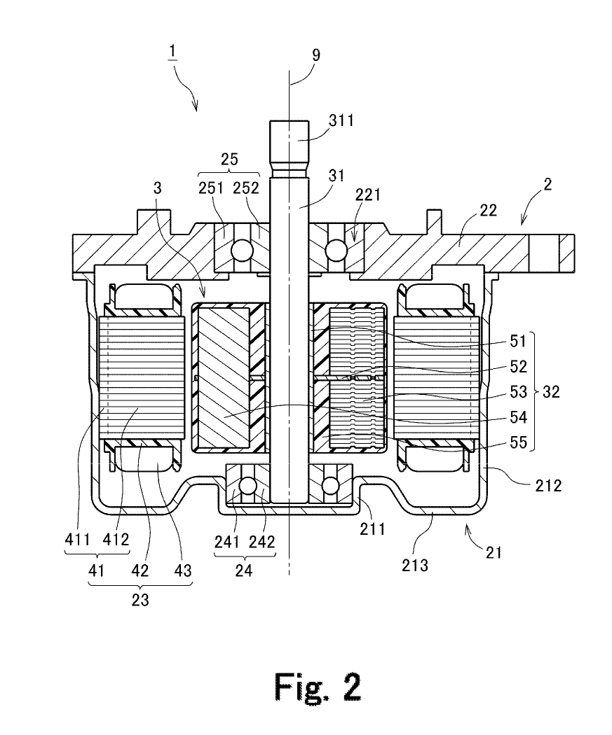

FIG. 2 is a vertical sectional view of the motor 1 according to the second preferred embodiment. As shown in FIG. 2, the motor 1 preferably includes a stationary unit 2 and a rotary unit 3. The stationary unit 2 is preferably fixed to a frame of a device to be driven. The rotary unit 3 is supported to rotate with respect to the stationary unit 2.

In the present preferred embodiment, the stationary unit 2 preferably includes a housing 21, a cover 22, a stator unit 23, a lower bearing 24, and an upper bearing 25.

The housing 21 preferably includes a substantially cylindrical sidewall 212 and a bottom portion 213 closing the lower portion of the sidewall 212. The cover 22 is arranged to cover an upper opening of the housing 21. The stator unit 23 and the rotor unit 32 (to be described later) are preferably accommodated within an internal space surrounded by the housing 21 and the cover 22. A depressed portion 211 in which the lower bearing 24 is arranged is preferably defined in the central region of the bottom portion 213 of the housing 21. A circular hole 221 in which the upper bearing 25 is arranged is preferably defined in the central region of the cover 22.

The stator unit 23 is an armature arranged to generate magnetic fluxes when a drive current is supplied thereto. The stator unit 23 preferably includes a stator core 41, an insulator 42, and coils 43. The stator core 41 is preferably defined by, e.g., a plurality of axially laminated steel plates. However, any other desirable type of stator core could be used instead. The stator core 41 preferably includes an annular core-back 411 and a plurality of teeth 412 protruding radially inward from the core-back 411. The core-back 411 is preferably fixed to the inner circumferential surface of the sidewall 212 of the housing 21. The teeth 412 are arranged at a substantially equal interval along the circumferential direction.

The insulator 42 is preferably made of, for example, an insulating resin body and is attached to the teeth 412. Each of the teeth 412 is preferably covered by the insulator 42 with the radial inner end thereof kept exposed. The coils 43 are preferably defined by conductive wires wound around the insulator 42. The insulator 42 is arranged between each of the teeth 412 and each of the coils 43, thereby preferably preventing the teeth 412 and the coils 43 from being electrically short-circuited. The teeth 412 and the coils 43 may be insulated in other manners instead of using the insulator 42 such as, for example, applying an insulating coating on the surfaces of the teeth 412, wrapping the coils with an insulating material, etc.

The lower bearing 24 and the upper bearing 25 are arranged between the housing 21, the cover 22, and the shaft 31 of the rotary unit 3. In the present preferred embodiment, ball bearings in which inner and outer races are rotated relative to each other with balls interposed between the inner and outer races are preferably used as the lower bearing 24 and the upper bearing 25. However, other bearings such as slide bearings or fluid bearings may be used instead of the ball bearings.

The outer race 241 of the lower bearing 24 is preferably arranged within the depressed portion 211 of the housing 21 and is fixed to the housing 21. The outer race 251 of the upper bearing 25 is preferably arranged within the circular hole 221 of the cover 22 and is fixed to the cover 22. On the other hand, the inner races 242 and 252 of the lower bearing 24 and the upper bearing 25 are preferably fixed to the shaft 31. Thus the shaft 31 is supported to rotate with respect to the housing 21 and the cover 22.

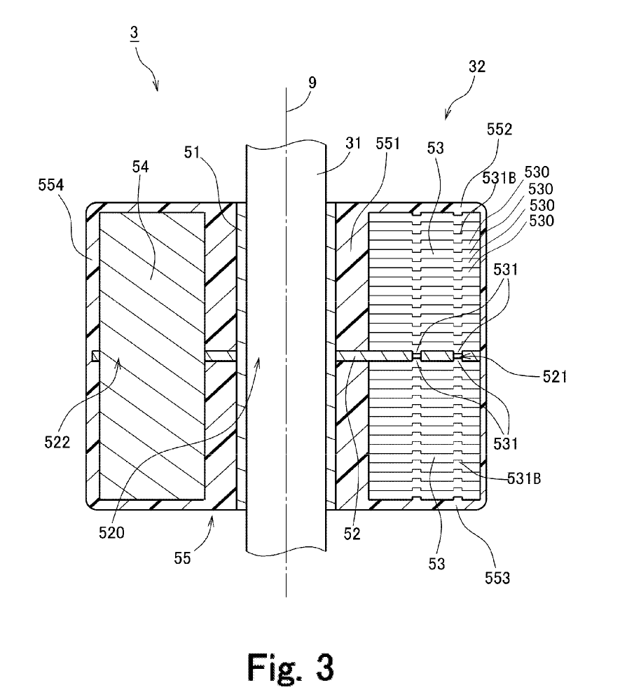

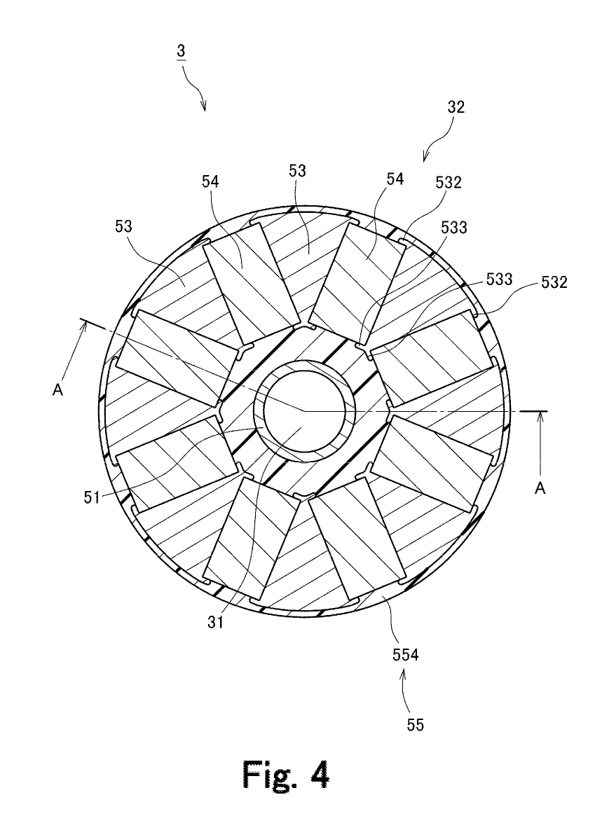

FIG. 3 is a vertical sectional view of the rotary unit 3. FIG. 4 is a horizontal sectional view of the rotary unit 3. The cross section of the rotary unit 3 shown in FIGS. 2 and 3 corresponds to the cross section taken along line A-A in FIG. 4. As shown in FIGS. 2 through 4, the rotary unit 3 of the present preferred embodiment preferably includes a shaft 31 and a rotor unit 32.

The shaft 31 is preferably a columnar metal member extending along the center axis 9. The shaft 31 is supported by the lower bearing 24 and the upper bearing 25 and is rotated about the center axis 9. As shown in FIG. 2, the shaft 31 preferably includes a head portion 311 protruding upward beyond the cover 22. The head potion 311 is preferably connected to, for example, a steering device of a motor vehicle or the like by way of a power transmission mechanism such as, for example, a gear and so forth.

The rotor unit 32 is preferably arranged radially inward of the stator unit 23 and is rotated together with the shaft 31. The rotor unit 32 of the present preferred embodiment preferably includes a cylinder member 51, a ring-shaped plate 52, a plurality of core pieces 53, a plurality of magnets 54, and a resin-molded member 55. Detailed structures of the respective components of the rotor unit 32 will be described later.

In the motor 1, when a drive current is supplied to the coils 43 of the stationary unit 2, radial magnetic fluxes are generated in the teeth 412 of the stator core 41. Circumferential torque is generated by the action of the magnetic fluxes between the teeth 412 and the magnets 54. As a result, the rotary unit 3 is rotated about the center axis 9 with respect to the stationary unit 2.

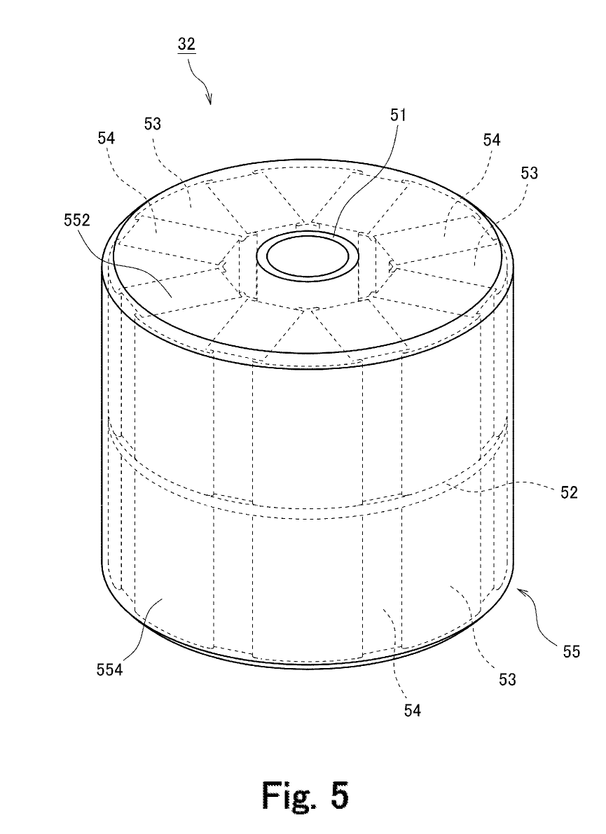

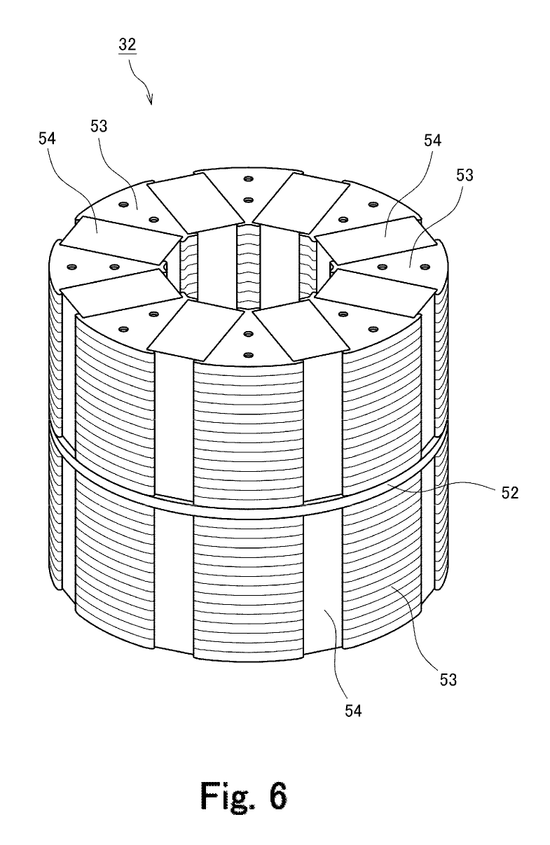

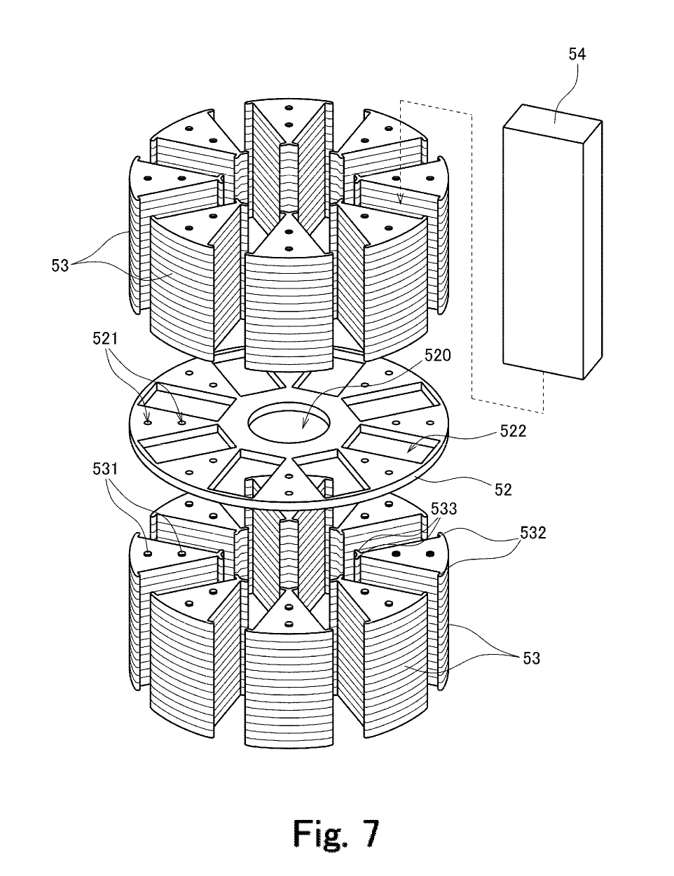

FIG. 5 is a perspective view of the rotor unit 32. FIG. 6 is a perspective view of the rotor unit 32 with the cylinder member 51 and resin-molded member 55 removed for clarity. FIG. 7 is an exploded perspective view of the ring-shaped plate 52, the core pieces 53 and the magnet 54. Detailed structures of the rotor unit 32 will now be described with reference to FIGS. 3 through 7.

The cylinder member 51 is preferably a metal member axially extending in a cylindrical shape. As shown in FIGS. 3 through 5, the cylinder member 51 is preferably attached to the outer circumferential surface of the shaft 31. The shaft 31 is preferably, for example, press-fitted to the inside of the cylinder member 51.

The ring-shaped plate 52 is positioned radially outward of the cylinder member 51 and preferably extends into a substantially disc-shaped shape in the radial direction and the circumferential direction. The ring-shaped plate 52 preferably has a circular hole 520 provided in the central region thereof. The cylinder member 51 is inserted into the circular hole 520. The ring-shaped plate 52 preferably includes a plurality of first through-holes 521 and a plurality of second through-holes 522, all of which are arranged radially outward of the circular hole 520. The ring-shaped plate 52 is preferably made of non-magnetic metal such as, e.g., aluminum, aluminum alloy, austenitic stainless steel, copper alloy, etc.

The core pieces 53 are preferably arranged above and below the ring-shaped plate 52 at an equal or substantially equal interval in the circumferential direction. Each of the core pieces 53 is preferably provided by substantially sector-shaped steel plates 530 axially laminated one above another. Electromagnetic steel plates are preferably used as the steel plates 530. The outer circumferential surface of the ring-shaped plate 52 and the outer circumferential surfaces of the core pieces 53 are arranged in the same or substantially in the same radial position. Each of the steel plates 530 preferably includes a protrusion 531, the rear portion of which is defined by a recess. The protrusion 531 of one of the steel plates is preferably, for example, press-fitted to the recess of the axially adjoining steel plate. In this structure, the steel plates 530 are coupled together, thereby defining each of the core pieces 53. In the following description, the coupling structure in which two steel plates are coupled together by, for example, press-fitting a protrusion to a recess will be referred to as a caulking portion. The protrusion 531 of each of the steel plates is preferably formed by, for example, a press working. For that reason, the recess is positioned at the opposite side of the protrusion 531 of each of the steel plates. The steel plates each having the protrusion 531 and the recess may preferably be produced, for example, through a cutting work. In that case, the opposite side of the protrusion need not necessarily be the recess. The protrusion and the recess may be arranged in arbitrary positions.

A pair of protrusions 531 is preferably provided on the surface of each of the core pieces 53 making contact with the ring-shaped plate 52, namely on the lower surface the core piece 53 arranged just above the ring-shaped plate 52 and on the upper surface of the core piece 53 arranged just below the ring-shaped plate 52. The protrusions 531 are the protrusions of the steel plate 530 adjoining the ring-shaped plate 52 among other protrusions 531 of the steel plates 530 defining the core pieces 53. In the present preferred embodiment, each of the core pieces includes two caulking portions arranged to fix the steel plates 530 together. Due to the existence of the caulking portions, a pair of protrusions 531 is preferably provided on the end surface of each of the core pieces 53. The number of the protrusions 531 provided on the end surface of each of the core pieces 53 may be one or three or more.

On the other hand, as shown in FIG. 7, the first through-holes 521 of the ring-shaped plate 52 are preferably arranged at a substantially equal interval along the circumferential direction. The protrusions 531 of the respective core pieces 53 are preferably, for example, press-fitted to the first through-holes 521 of the ring-shaped plate 52. Thus the respective core pieces 53 are fixed to the ring-shaped plate 52 and are position-determined in the circumferential direction and the radial direction. Upon driving the motor 1, centrifugal forces are applied to the core pieces 53. Since the protrusions 531 and the first through-holes 521 are coupled together, the core pieces 53 are preferably prevented from scattering radially outward.

In another preferred embodiment of the present invention, it is possible that a ring-shaped plate and core pieces are fixed together by axially-penetrating pins such that it is necessary to form through-holes arranged to permit insertion of the pins in the core pieces. In that case, due to the through-holes, a magnetic resistance of each of the core pieces is increased. However, if the core pieces 53 are fixed to the ring-shaped plate 52 by use of the protrusions 531 in the manner as described above, there is no need to provide a through-hole in each of the core pieces 53. Accordingly, it is possible to reduce a magnetic resistance of each of the core pieces 53.

In the present preferred embodiment, the protrusions 531 of the core piece 53 arranged just above the ring-shaped plate 52 and the protrusions 531 of the core piece 53 arranged just below the ring-shaped plate 52 are preferably, for example, press-fitted to first through-holes 521 of the ring-shaped plate 52, thereby defining the caulking portions. In other words, the ring-shaped plate 52 is provided with the first through-holes 521. The steel plates defining the core pieces 53 are provided with the protrusions. Among other protrusions, the protrusions 531 of the steel plates axially adjoining the ring-shaped plate 52 are press-fitted to the first through-holes 521. The common first through-holes 521 are used to fix the upper and lower core pieces 53. This makes it possible to reduce the number of the first through-holes 521 defined in the ring-shaped plate 52. As a result, it is possible to mitigate any reduction of the rigidity of the ring-shaped plate 52 which may be caused by the first through-holes 521. Instead of the first through-holes 521, recesses may alternatively be provided in the ring-shaped plate 52. The protrusions 531 of the core pieces 53 may be fitted to the recesses. Alternatively, protrusions may be provided in the ring-shaped plate 52 and recesses may be provided in the core pieces 53. The protrusions and the recesses thus provided may be fitted to each other.

The magnets 54 are preferably arranged at an equal or a substantially equal interval along the circumferential direction. The circumferential opposite end surfaces of each of the magnets 54 become magnetic pole surfaces. The magnets 54 are arranged such that the magnetic pole surfaces having the same pole are opposed to each other in the circumferential direction. As shown in FIG. 4, the core pieces 53 and the magnets 54 are alternately arranged along the circumferential direction when seen in a plan view. Each of the core pieces 53 is magnetized by the magnets 54 arranged at the opposite sides thereof. As a consequence, the radial outer surfaces of the core pieces 53 become magnetic pole surfaces. That is to say, the magnetic fluxes generated in the magnets 54 extend radially outward of the core pieces 53 through the core pieces 53.

As set forth above, each of the core pieces 53 is preferably defined by laminated steel plates. The surfaces of the respective electromagnetic steel plates defining the laminated steel plates are preferably covered with insulating films. This reduces an eddy-current loss in each of the core pieces 53. In the present preferred embodiment, the rotor core is preferably defined by the upper and lower core pieces 53 arranged in two stages. The ring-shaped plate 52 is arranged between the upper core pieces 53 and the lower core pieces 53. The ring-shaped plate 52 is preferably made of a non-magnetic body. This ring-shaped plate 52 further reduces an eddy-current loss in the rotor core.

If the core pieces 53 are arranged in multiple stages along the axial direction, it becomes possible to easily increase the axial dimension of the rotor core. This makes it possible to expand the magnetic path within the rotor core and to increase the torque of the motor 1.

As shown in FIG. 7, the second through-holes 522 of the ring-shaped plate 52 are preferably arranged at an equal or a substantially equal interval along the circumferential direction. In the present preferred embodiment, the respective magnets 54 preferably extend in the axial direction through the second through-holes 522 of the ring-shaped plate 52. This makes it possible to reduce a required number of the magnets 54 as compared with a case where different magnets are arranged above and below the ring-shaped plate 52. Accordingly, it is possible to reduce the manufacturing cost of the magnets 54 and the number of assembling steps of the rotor unit 32.

Each of the core pieces 53 preferably include a pair of outer claws 532 protruding in the circumferential direction at the radial outer side of each of the magnets 54 and a pair of inner claws 533 protruding in the circumferential direction at the radial inner side of each of the magnets 54. Each of the magnets 54 is preferably arranged between the adjoining core pieces 53 to make contact with the circumferential end surface of each of the core pieces 53, the radial inner surface of each of the outer claws 532 and the radial outer surface of each of the inner claws 533. That is to say, the circumferential opposite end portions of each of the magnets 54 preferably radially overlap with the outer claws 532 and the inner claws 533.

Thus, the magnets 54 are fixed with respect to the core pieces 53 and are position-determined in the radial direction and the circumferential direction. Upon driving the motor 1, centrifugal forces are applied to the magnets 54. Due to the contact of the magnets 54 with the outer claws 532, the magnets 54 are prevented from scattering radially outward during rotation of the rotor 3.

The resin-molded member 55 is preferably arranged to encapsulate the cylinder member 51, the ring-shaped plate 52, the core pieces 53, and the magnets 54 by, for example, insertion molding. As shown in FIGS. 3 through 5, the resin-molded member 55 preferably includes an inner resin portion 551, an upper resin portion 552, a lower resin portion 553, and an outer resin portion 554.

The inner resin portion 551 is preferably arranged radially inward of the core pieces 53 and the magnets 54 and radially outward of the cylinder member 51. In the motor 1, the core pieces 53 are preferably not joined to one another at the radial inner side thereof. Instead, the non-magnetic inner resin portion 551 fills the radial inner region of the core pieces 53 and the magnets 54. This arrangement preferably restrains the magnetic fluxes from being leaked radially inward from the core pieces 53 and the magnets 54. For that reason, the magnetic fluxes generated in the magnets 54 can efficiently flow toward the stator unit 23. This makes it possible to generate torque in an efficient manner.

The inner circumferential surface of the inner resin portion 551 preferably makes contact with the outer circumferential surface of the cylinder member 51. The diameter of the outer circumferential surface of the cylinder member 51 is larger than the diameter of the outer circumferential surface of the shaft 31. For that reason, the contact area between a metal and a resin becomes larger when the inner resin portion 551 is brought into contact with the outer circumferential surface of the cylinder member 51 than when the inner resin portion 551 is brought into contact with the outer circumferential surface of the shaft 31. Therefore, the inner resin portion 551 is preferably strongly fixed to the cylinder member 51. The contact area between the cylinder member 51 and the inner resin portion 551 preferably may be further increased by forming, for example, irregularities on the outer circumferential surface of the cylinder member 51.

The upper resin portion 552 extends radially outward from the upper end portion of the inner resin portion 551. The lower resin portion 553 extends radially outward from the lower end portion of the inner resin portion 551. The core pieces 53 and the magnets 54 are preferably arranged between the upper resin portion 552 and the lower resin portion 553. This prevents the core pieces 53 and the magnets 54 from being removed upward or downward.

The outer resin portion 554 preferably extends into a cylindrical shape at the radial outer side of the core pieces 53 and the magnets 54. The upper end portion of the outer resin portion 554 is preferably connected to the radial outer edge of the upper resin portion 552. The lower end portion of the outer resin portion 554 is connected to the radial outer edge of the lower resin portion 553. The radial inner surface of the outer resin portion 554 preferably makes contact with the radial outer surfaces of the core pieces 53 and the magnets 54.

In this regard, the thickness of the outer resin portion 554 is preferably smaller than the thickness of the upper resin portion 552 and the thickness of the inner resin portion 551. The thinner the outer resin portion 554, the shorter the distance between the core pieces 53 and the teeth 412. Thus, the magnetic fluxes are efficiently moved from the core pieces 53 toward the teeth 412.

When molding the resin-molded member 55, the cylinder member 51, the ring-shaped plate 52, the core pieces 53, and the magnets 54 are preferably first arranged in a cavity defined by a pair of molds. The positions of the core pieces 53 within the molds are decided by the ring-shaped plate 52. The positions of the magnets 54 within the molds are decided by the core pieces 53. For that reason, a structure that determines the positions of the core pieces 53 and the magnets 54 need not be provided in the molds.

Subsequently, a molten resin is admitted into an empty space within the molds. The molten resin is spread out along the surfaces of the cylinder member 51, the ring-shaped plate 52, the core pieces 53, and the magnets 54. Thereafter, the molten resin is allowed to cure. Consequently, the resin-molded member 55 having the inner resin portion 551, the upper resin portion 552, the lower resin portion 553 and the outer resin portion 554 is molded.

During the insertion molding process, the molten resin preferably applies a pressure to the respective members. In particular, the core pieces 53 and the magnets 54 are easy to receive radial pressures from the molten resin because the molten resin is filled in the radial inner side and the radial outer side of the core pieces 53 and the magnets 54. However, the radial positions of the core pieces 53 are fixed as the protrusions 531 are, for example, press-fitted to the first through-holes 521 of the ring-shaped plate 52. Accordingly, even if the core pieces 53 receive pressures from the molten resin, no deviation, or barely no deviation is generated in the radial positions of the core pieces 53.

The radial positions of the magnets 54 are preferably fixed by the outer claws 532 and the inner claws 533 of the core pieces 53. Even if the magnets 54 are pressed radially outward by the molten resin filled in the radial inner side of the magnets 54, the outer claws 532 prevent or substantially prevent the positions of the magnets 54 from being deviated radially outward. Moreover, even the magnets 54 are pressed radially inward by the molten resin filled in the radial outer side of the magnets 54, the inner claws 533 prevent or substantially prevent the positions of the magnets 54 from being deviated radially inward.

A space through which the molten resin passes may be defined between the circumference of the circular hole 520 of the ring-shaped plate 52 and the outer circumferential surface of the cylinder member 51. In FIG. 3, the circumference of the circular hole 520 of the ring-shaped plate 52 and the outer circumferential surface of the cylinder member 51 make contact with each other. In a case where a resin gate hole is formed at the side of the upper resin portion 552, there is a possibility that the molten resin may not spread out toward the lower resin portion 553 and the inner resin portion 551 existing axially below the ring-shaped plate 52. In other words, the ring-shaped plate 52 prevents the molten resin from flowing from the axial upper side toward the axial lower side. Thus, the molten resin can flow along only the outer circumferential surfaces of the core pieces 53 and the magnets 54. In that case, the molten-resin-passing gap on the outer circumferential surfaces of the core pieces 53 and the magnets 54 is small, thereby worsening the flow of the molten resin. Therefore, it is likely that the molten resin may not be spread out toward the lower resin portion 553 and the inner resin portion 551 existing axially below the ring-shaped plate 52. Accordingly, it is desirable that a space through which the molten resin passes preferably be defined between the circumference of the circular hole 520 of the ring-shaped plate 52 and the outer circumferential surface of the cylinder member 51.

While illustrative preferred embodiments of the present invention have been described above, the present invention is not limited to the aforementioned preferred embodiments.

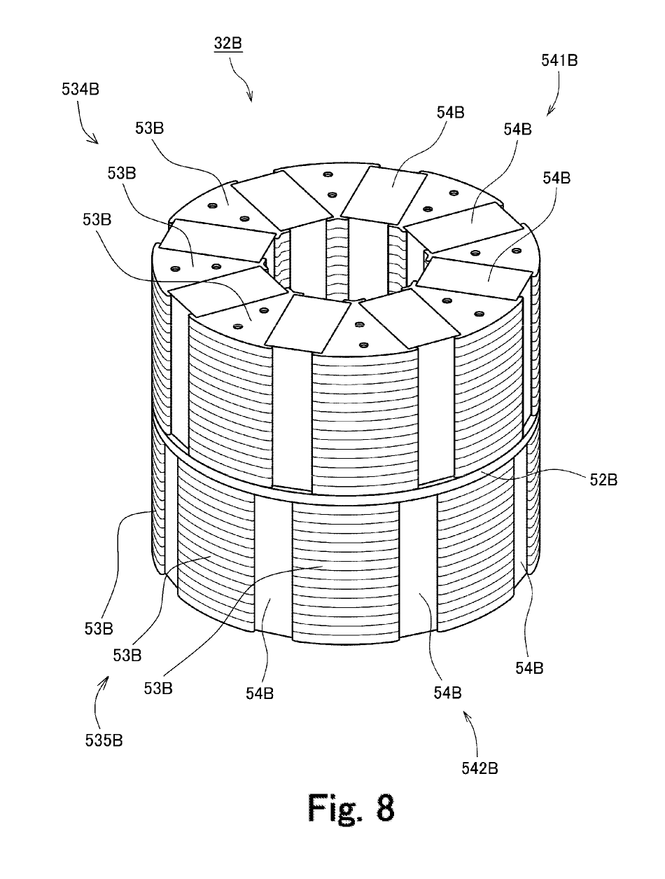

FIG. 8 is a perspective view showing a rotor unit 32B according to one modified example of a preferred embodiment of the present invention. In the example shown in FIG. 8, magnets 54B are arranged in two upper and lower stages. In other words, the magnets 54B shown in FIG. 8 preferably include an upper magnet group 541B in which the magnets 54B are arranged along the circumferential direction at the upper side of the ring-shaped plate 52B and a lower magnet group 542B in which the magnets 54B are arranged along the circumferential direction at the lower side of the ring-shaped plate 52B. Similarly, core pieces 53B are arranged in two upper and lower stages. The core pieces 53B preferably include an upper core piece group 534B in which the core pieces 53B are arranged along the circumferential direction at the upper side of the ring-shaped plate 52B and a lower core piece group 535B in which the core pieces 53B are arranged along the circumferential direction at the lower side of the ring-shaped plate 52B. With this configuration, the through-holes for insertion of the magnets 54B need not be provided in the ring-shaped plate 52B. This makes it possible to further increase the rigidity of the ring-shaped plate 52B.

In the modified example of a preferred embodiment of the present invention shown in FIG. 8, the upper magnet group 541B and the lower magnet group 542B are preferably arranged such that the circumferential positions thereof are deviated from each other. In this state, the upper core piece group 534B and the lower core piece group 535B are also arranged such that the circumferential positions thereof are deviated from each other. With this configuration, the switching of the magnetic fluxes in the circumferential direction becomes gentle in the rotor unit 32B as a whole. Accordingly, torque ripple and cogging are reduced.

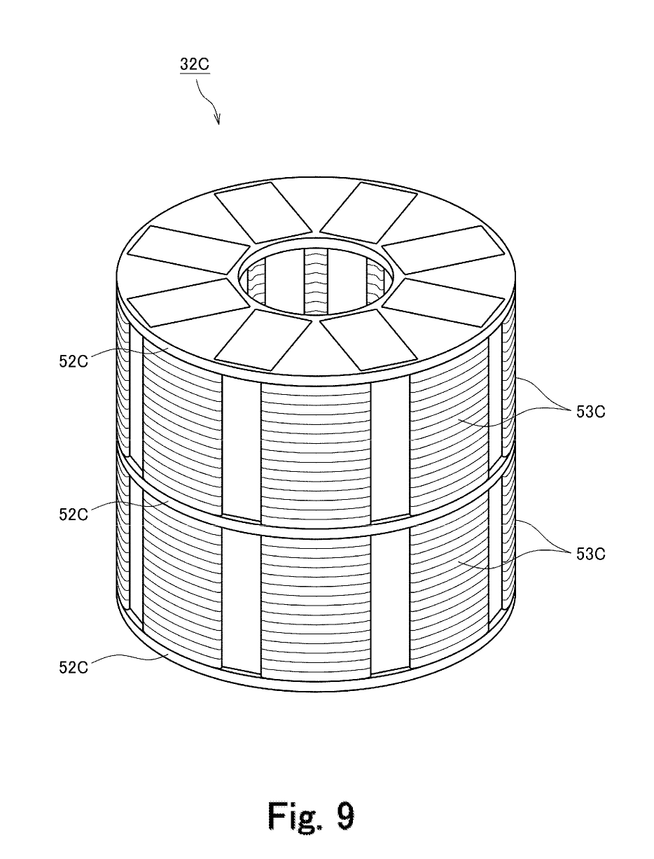

FIG. 9 is a perspective view showing a rotor unit 32C according to another modified example of a preferred embodiment of the present invention. In the example shown in FIG. 9, ring-shaped plates 52C are arranged between upper and lower core pieces 53C, above the upper core pieces 53C and below the lower core pieces 53C. The respective core pieces 53C are fixed to the three ring-shaped plates 52C. In this manner, the ring-shaped plates may be arranged in the uppermost and lowermost portions of the rotor core and between the core pieces arranged in multiple stages, thereby fixing the respective core pieces.

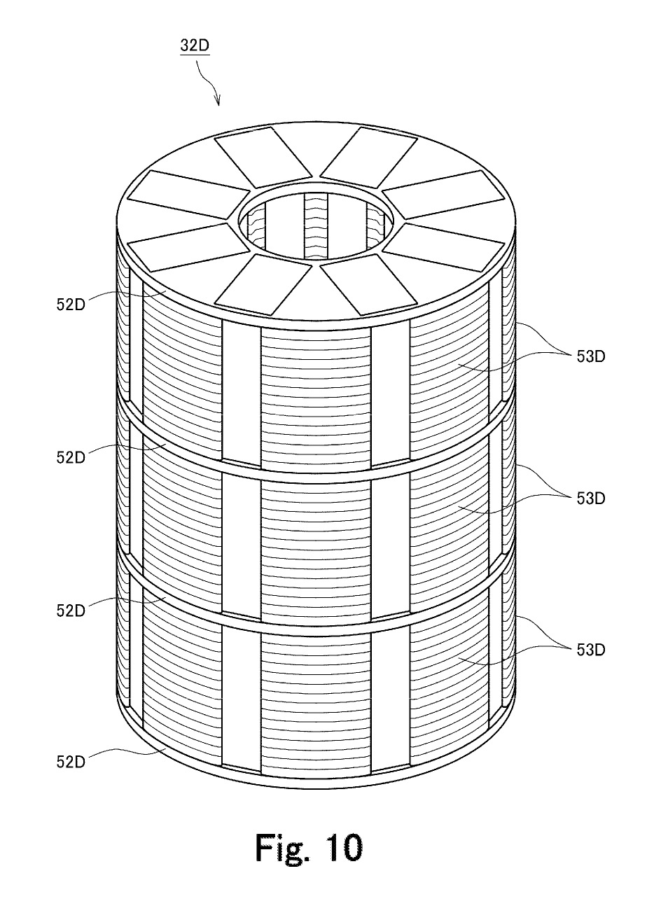

The core pieces may be arranged in three or more stages. For example, as in the rotor unit 32D shown in FIG. 10, core pieces 53D may be arranged in three upper, middle and lower stages. In the modified example of a preferred embodiment of the present invention shown in FIG. 10, ring-shaped plates 52D are arranged above the uppermost core pieces 53D, below the lowermost core pieces 53D and between the core pieces 53D of the respective stages. The respective core pieces 53D are fixed to one or two of the four ring-shaped plates 52D.

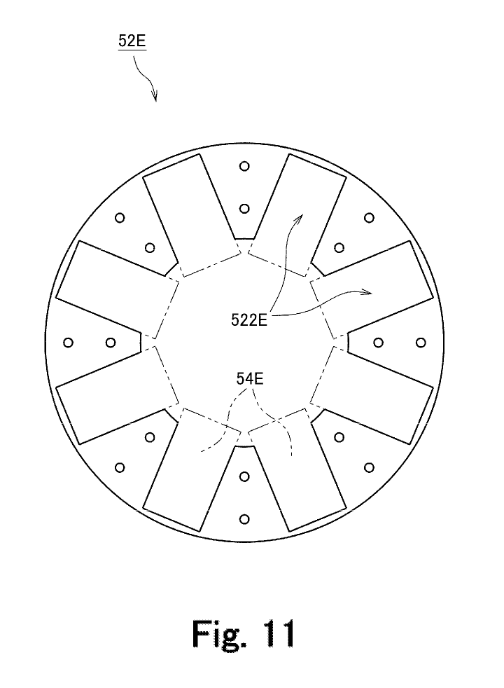

FIG. 11 is a plan view showing a ring-shaped plate 52E according to a further modified example of a preferred embodiment of the present invention. In FIG. 11, magnets 54E are indicated by double-dot chain lines. The ring-shaped plate 52E shown in FIG. 11 includes a plurality of cutouts 522E in place of the second through-holes. The magnets 54E are arranged within the cutouts 522E. Even with this configuration, the magnets 54E can be arranged to axially pass through the ring-shaped plate 52E. In order to increase the rigidity of the ring-shaped plate, it is however desirable to form the second through-holes and to widen the ring-shaped plate to the radial inner side of the magnets as in the aforementioned preferred embodiments of the present invention.

As a still further modified example of a preferred embodiment of the present invention, the inner resin portion of the resin-molded member may be changed to a non-magnetic metal portion. In other words, a non-magnetic inner metal portion may be provided radially inward of the core pieces and the magnets and radially outward of the shaft. The inner metal portion may preferably be made of, e.g., non-magnetic stainless steel. If the inner metal portion is non-magnetic, it is possible to prevent or substantially prevent magnetic fluxes from being leaked radially inward from the core pieces and the magnets.

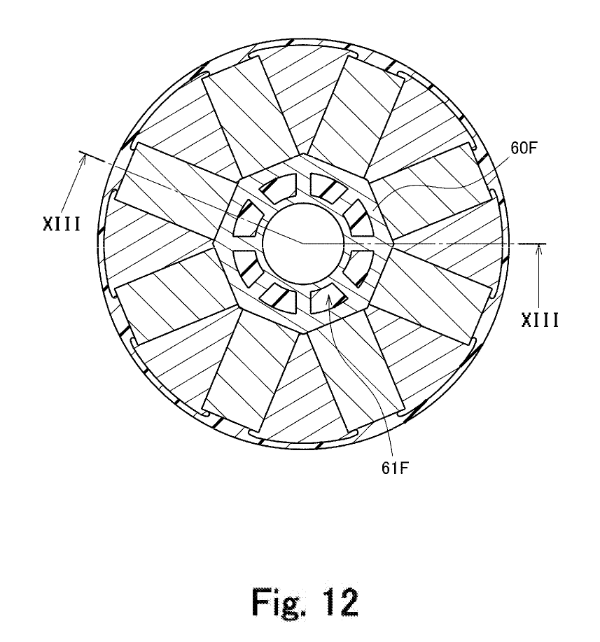

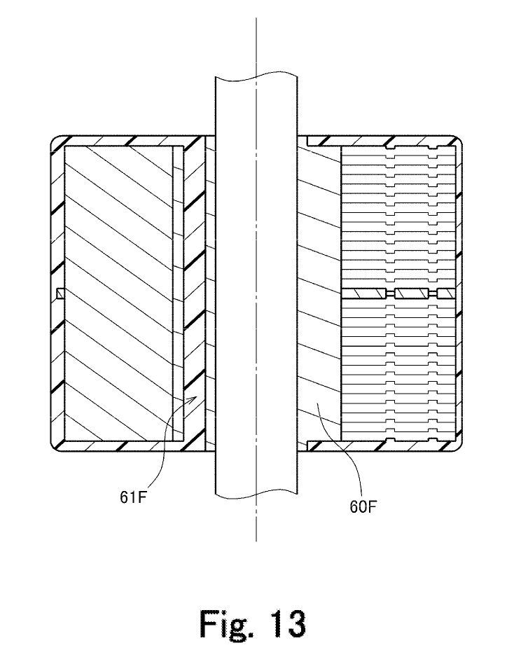

FIG. 12 is a horizontal section view of a rotary unit having an inner metal portion 60F. FIG. 13 is a vertical section view of the rotary unit taken along line XIII-XIII in FIG. 12. As shown in FIGS. 12 and 13, voids 61F through which a molten resin can flow from the axial upper side to the axial lower side may be defined inside the inner metal portion 60F. If the voids 61F are not provided and if the resin gate hole is defined at the side of the upper resin portion, there is a possibility that the molten resin may not be spread out to the lower resin portion. This is because the molten resin flows through a small gap provided on the outer circumferential surfaces of the core pieces and the magnets and because the flow of the molten resin grows worse. If the voids 61F extending in the axial direction are provided inside the inner metal portion 60F, it is possible to spread out the molten resin to the lower resin portion. The voids 61F may be arranged on the circumference of the inner metal portion 60F.

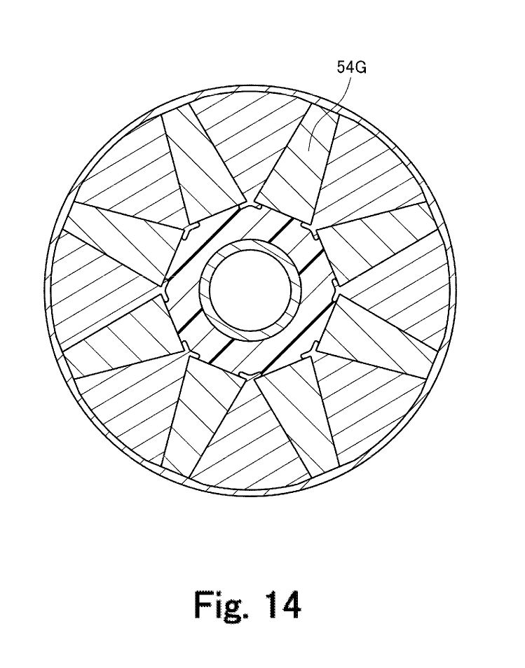

FIG. 14 is a horizontal section view of a rotary unit according to a yet still further modified example of a preferred embodiment of the present invention. As shown in FIG. 14, when seen in a cross section orthogonal to the center axis, each of the magnets 54G may have a trapezoidal shape such that the circumferential width of each of the magnets 54G is reduced radially outward. In that case, even if the outer claws are not provided, there is no possibility that the magnets 54G scatter radially outward.

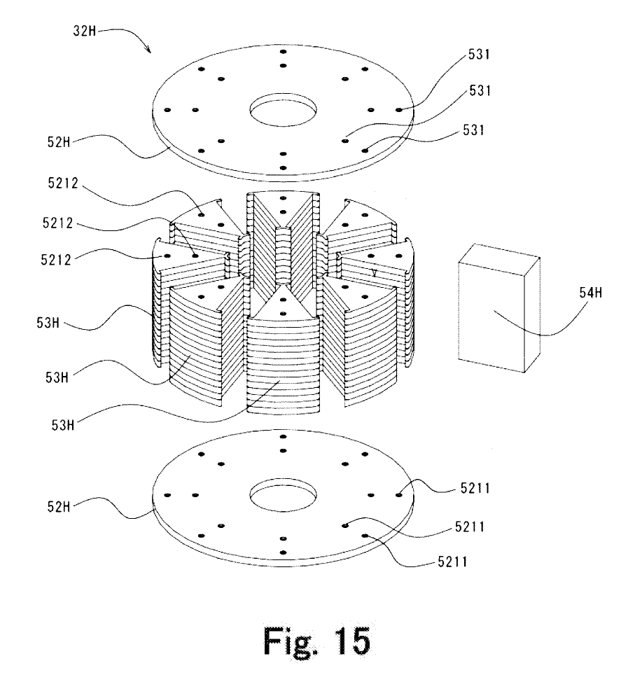

FIG. 15 is a perspective view showing a rotary unit according to an even yet still further modified example of a preferred embodiment of the present invention. A rotor unit 32H preferably includes two upper and lower ring-shaped plates 52H and core pieces 53H arranged between the upper and lower ring-shaped plates 52H. As shown in FIG. 15, each of the core pieces 53H preferably includes two recesses 5212 located on the upper surface thereof. The upper ring-shaped plate 52H preferably includes a plurality of protrusions 531 facing downward in FIG. 15. The protrusions 531 are preferably formed by subjecting a material of the upper ring-shaped plate 52H, preferably, for example, an austenitic stainless steel plate, to a press work. Recesses are left on the upper surface of the upper ring-shaped plate 52H.

The protrusions 531 are press-fitted to and inserted into the recesses 5212 of the core pieces 53H. A plurality of protrusions (not shown) is provided on the lower surface of each of the core pieces 53H. These protrusions are preferably, for example, press-fitted to and inserted into the recesses 5211 of the lower ring-shaped plate 52H. The core pieces 53H are fastened together by the two ring-shaped plates 52H. Magnets 54H are inserted between, and fixed to, two adjoining core pieces 53H. After fixing the core pieces 53H to the upper or lower ring-shaped plate 52H, the magnets 54H are inserted between the core pieces 53H. Thereafter, the remaining ring-shaped plate 52H is attached to the core pieces 53H.

In this modified example of a preferred embodiment of the present invention, the upper and lower portions of the core pieces 53H are preferably fixed by the ring-shaped plates 52H. This makes it possible to obtain a rotor unit having high strength. First through-holes may be provided in place of the recesses 5211 of the lower ring-shaped plate 52H. This makes it possible to avoid formation of protrusions on the lower surface of the rotor unit.

As another modified example of a preferred embodiment of the present invention, the first through-holes of the ring-shaped plate may be changed to recesses and the protrusions of the core pieces may be fitted to the recesses. Alternatively, protrusions may be defined in the ring-shaped plate and may be fitted to the recesses of the core pieces. In other words, the ring-shaped plate and the respective core pieces may be fixed to each other by combining the recesses provided in one of the ring-shaped plate and the respective core pieces and the protrusions provided in the other of the ring-shaped plate and the respective core pieces. The shape of the protrusions is not limited to the circular columnar shape but may be a rectangular shape or a V-shaped shape or other suitable shapes, for example.

The resin-molded member need not necessarily include the inner resin portion, the upper resin portion, the lower resin portion, and the outer resin portion. For example, the resin-molded member may alternatively include only the inner resin portion, the upper resin portion, and the lower resin portion.

As another modified example of a preferred embodiment of the present invention, no resin may be used in the rotor unit. In that case, it may be possible to mount a rotor cover covering the upper and lower end surfaces of the rotor unit and the outer circumferential surface of the core-back.

The magnets may preferably be made of, for example, ferrite or neodymium. In recent years, however, it has become difficult to use neodymium magnets due to the sudden increase in the price of neodymium as a rare earth material. For that reason, there is an increasing technical demand to obtain a strong magnetic force while using ferrite magnets. If the magnets and the core pieces are alternately arranged along the circumferential direction as in the preferred embodiments described above, it is possible to increase the volumetric ratio of the magnets in the rotor unit. Accordingly, it is possible to obtain a strong magnetic force while using ferrite magnets.

In addition, the detailed shapes of the respective members may differ from the shapes illustrated in the respective figures of the subject application. The respective components of the preferred embodiments and modified examples described above may be appropriately combined unless a conflict arises.

Preferred embodiments of the present invention are applicable to an inner-rotor-type motor, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor, comprising:
a stationary unit; and
a rotary unit arranged to rotate with respect to the stationary unit; wherein
the rotary unit includes a shaft arranged along a center axis extending in an up-down direction, a ring-shaped plate extending in a radial direction and a circumferential direction with respect to the center axis, a rotor core including a plurality of core pieces, and a plurality of magnets arranged along the circumferential direction;
the ring-shaped plate is made of a non-magnetic metal material;
each of the core pieces includes a plurality of axially-laminated steel plates;
each of the magnets includes circumferential opposite surfaces which are magnetic pole surfaces;
the magnets are arranged such that same poles are opposed to each other in the circumferential direction, and the core pieces and the magnets are alternately arranged in the circumferential direction;
each of the steel plates includes a protrusion and a recess, at least a portion of the protrusion of each of the steel plates is fitted to the recess of another axially-adjoining steel plates;
the ring-shaped plate includes a protrusion, a recess, or a first through-hole; and
at least a portion of the protrusion of the steel plate axially adjoining the ring-shaped plate is fitted to the recess or the first through-hole of the ring-shaped plate, or at least a portion of the protrusion of the ring-shaped plate is fitted to the recess of the steel plate axially adjoining the ring-shaped plate.

2. The motor of claim 1, wherein the rotary unit further includes an upper resin portion positioned above the rotor core and extending radially outward, a lower resin portion positioned below the rotor core and extending radially outward, and an outer resin portion interconnecting a radial outer end of the upper resin portion and a radial outer end of the lower resin portion and making contact with radial outer surfaces of the magnets, the core pieces, the magnets, and the ring-shaped plate being arranged between the upper resin portion and the lower resin portion.

3. The motor of claim 2, wherein the rotary unit further includes an inner resin portion located between the rotor core, the magnets, and the shaft.

4. The motor of claim 2, wherein the rotary unit further includes an inner resin portion provided between the rotor core, the magnets, and the shaft, the inner resin portion including an upper end connected to the upper resin portion and a lower end connected to the lower resin portion.

5. The motor of claim 2, wherein the rotary unit further includes a metal cylinder member fixed to the shaft, the cylinder member including an outer circumferential surface that contacts an inner circumferential surface of the inner resin portion.

6. The motor of claim 1, wherein the core pieces include a group of upper core pieces positioned above the ring-shaped plate and arranged along the circumferential direction and a group of lower core pieces positioned below the ring-shaped plate and arranged along the circumferential direction.

7. The motor of claim 2, wherein the core pieces include a group of upper core pieces positioned above the ring-shaped plate and arranged along the circumferential direction and a group of lower core pieces positioned below the ring-shaped plate and arranged along the circumferential direction.

8. The motor of claim 4, wherein the core pieces include a group of upper core pieces positioned above the ring-shaped plate and arranged along the circumferential direction and a group of lower core pieces positioned below the ring-shaped plate and arranged along the circumferential direction.

9. The motor of claim 1, wherein the ring-shaped plate includes a plurality of second through-holes arranged along the circumferential direction and the magnets axially extend through the second through-holes.

10. The motor of claim 2, wherein the ring-shaped plate includes a plurality of second through-holes arranged along the circumferential direction and the magnets axially extend through the second through-holes.

11. The motor of claim 1, wherein the ring-shaped plate includes two ring-shaped plates between which the core pieces are arranged.

12. The motor of claim 2, wherein the ring-shaped plate includes two ring-shaped plates between which the core pieces are arranged.

13. The motor of claim 3, wherein the ring-shaped plate includes two ring-shaped plates between which the core pieces are arranged.

14. The motor of claim 4, wherein the ring-shaped plate includes two ring-shaped plates between which the core pieces are arranged.

15. The motor of claim 6, wherein the ring-shaped plate includes three ring-shaped plates, the group of upper core pieces and the group of lower core pieces being arranged above and below one of the three ring-shaped plates, the remaining two of the three ring-shaped plates being respectively arranged above the group of upper core pieces and below the group of lower core pieces.

16. The motor of claim 7, wherein the ring-shaped plate includes three ring-shaped plates, the group of upper core pieces and the group of lower core pieces being arranged above and below one of the three ring-shaped plates, the remaining two of the three ring-shaped plates being respectively arranged above the group of upper core pieces and below the group of lower core pieces.

17. The motor of claim 6, wherein the group of upper core pieces and the group of lower core pieces are arranged such that the circumferential positions thereof are deviated from each other.

18. The motor of claim 8, wherein the group of upper core pieces and the group of lower core pieces are arranged such that the circumferential positions thereof are deviated from each other.

19. The motor of claim 15, wherein the group of upper core pieces and the group of lower core pieces are arranged such that the circumferential positions thereof are deviated from each other.

20. The motor of claim 1, wherein each of the core pieces includes an outer claw positioned radially outward of each of the magnets and protruding in the circumferential direction, at least one of circumferential opposite end portions of each of the magnets radially overlapping with the outer claw.
